(19) United States
(12) Patent Application Publication
(10) Pub. No.: US 2025/0381087 A1
(43) Pub. Date: Dec. 18, 2025

(54) CASKET TRANSPORT MECHANISM

(71) Applicant: STONEBROOKE EQUIPMENT, INC., Rosemount, MN (US)

(72) Inventors: Jerry D. Holman, Lakeville, MN (US); John S. Holman, Lakeville, MN (US); Pryce Z. Wigginton, Rosemount, MN (US)

(21) Appl. No.: 19/236,063

(22) Filed: Jun. 12, 2025

Related U.S. Application Data
(60) Provisional application No. 63/659,751, filed on Jun. 13, 2024.

(51) Int. Cl. A61G 21/00; B60P 1/02; B60P 1/64

(52) U.S. Cl. CPC A61G 21/00; B60P 1/02; B60P 1/6427; B60P 1/6454; B60P 1/649

(57) ABSTRACT

A casket transport mechanism having a lower platform for the receipt of one or more caskets and an upper platform for the receipt of one or more caskets. A support structure supports the upper platform, which is cantilevered at the front end from the support structure. A lift mechanism is operatively coupled to the upper platform to move the upper platform along the support structure between a raised position and a lowered position. The upper platform remains substantially parallel to the lower platform as it moves between the raised and lowered positions. In this way, the upper platform can be lowered to facilitate loading caskets onto it, and then raised to its raised position to allow loading of caskets onto the lower platform.

### CROSS-REFERENCE TO RELATED APPLICATION

The present application claims the benefit of U.S. Provisional Patent Application No. 63/659,751, filed Jun. 13, 2024, the disclosure of which is incorporated herein by reference in their entirety.

### TECHNICAL FIELD

This invention relates generally to transport loading devices and more specifically to a casket transport mechanism for loading caskets into a transport vehicle.

### BACKGROUND OF THE INVENTION

Known casket transport devices for transporting four caskets in a single vehicle are very complex. All known casket transports have an upper platform and a lower platform, each of which receives caskets that are loaded from the rear of the device. The bottom platform has a ramp that allows caskets to be slid up and onto the lower platform. The upper platform must be tilted to allow access for additional caskets to be loaded.

The problem with known devices is that the upper platform is normally tilted downward at one end to receive caskets. This results in a very steep incline upon which caskets must be slid upward to load. This is a disadvantage in known transports because it requires great effort by individuals loading caskets onto the steeply inclined upper platform. It is very difficult for the users to push the caskets uphill. Additionally, the known devices have complicated linkages to support the upper platform and allow the upper platform to tilt at an angle with respect to the lower platform.

What is needed is a mechanism that has very few moving parts, is easy to maintain and less costly to manufacture. Also, what is needed is a mechanism that is easier to load.

### SUMMARY OF THE INVENTION

The casket transport of the present invention has the advantage of moving vertically without needing to be tilted. It also provides a simplified mechanism for transporting caskets. There are minimal moving parts, which results in a lower cost structure and less maintenance.

Vertical movement of the top platform with respect to the lower platform and moving the top platform closely adjacent to or even engaging the lower platform provides for more effortless loading of caskets onto the casket transport. In the present invention, the upper platform is basically at the same height and flat with respect to the lower platform when caskets are loaded. A small incline ramp on the upper platform mates with the liftgate on the lower platform, leaving only a very slight incline making loading the upper platform much easier and ergonomically sound.

The present invention provides a casket transport mechanism having a lower platform for the receipt of one or more caskets and an upper platform having a front end and a rear end, for receipt of one or more caskets which are loaded at the rear end. A support structure supports the upper platform, which is cantilevered at the front end from the support structure. The disclosed invention supports the upper platform from the front end with two posts. This makes installation easier since only two posts are required to be mounted.

A lift mechanism is operatively coupled to the upper platform to move the upper platform along the support structure between a raised position and a lowered position. The upper platform remains substantially parallel to the lower platform as it moves between the raised and lowered positions. In this way, the upper platform can be lowered to facilitate the loading of caskets onto the upper platform, and then the upper platform can be raised to the raised position to allow loading of caskets onto the lower platform.

Vertical movement of the top platform with respect to the lower platform and close positioning of the top platform with respect to the lower platform provides for easier loading of caskets into the casket transport. Many known existing casket transports angle the upper platform with respect and the lower platform creating a steep incline for loading caskets. This is a disadvantage in known transports because it requires great effort by individuals loading caskets onto the steeply inclined upper platform. In the present invention, the upper platform is basically at the same height and flat with respect to the lower platform. A small incline ramp mates with the liftgate, leaving only a very slight incline and makes loading the upper platform much easier and ergonomically sound.

### BRIEF DESCRIPTION OF THE DRAWINGS

FIG. 1 is a perspective view of the casket transport mechanism of the present invention in the raised position.

FIG. 2 is a perspective view of the casket transport mechanism of the present invention in the lowered position.

FIG. 3 is an end view of the casket transport mechanism of the present invention in the lowered position.

FIG. 4 is a partial perspective view of the casket transport lift mechanism of the present invention mounted in a vehicle.

FIG. 5 is a partial perspective view of the casket transport lift mechanism of the present invention mounted in a vehicle.

FIG. 6 is a partial perspective view of the casket transport mechanism of the present invention mounted in a vehicle.

### DETAILED DESCRIPTION OF A PREFERRED EMBODIMENT

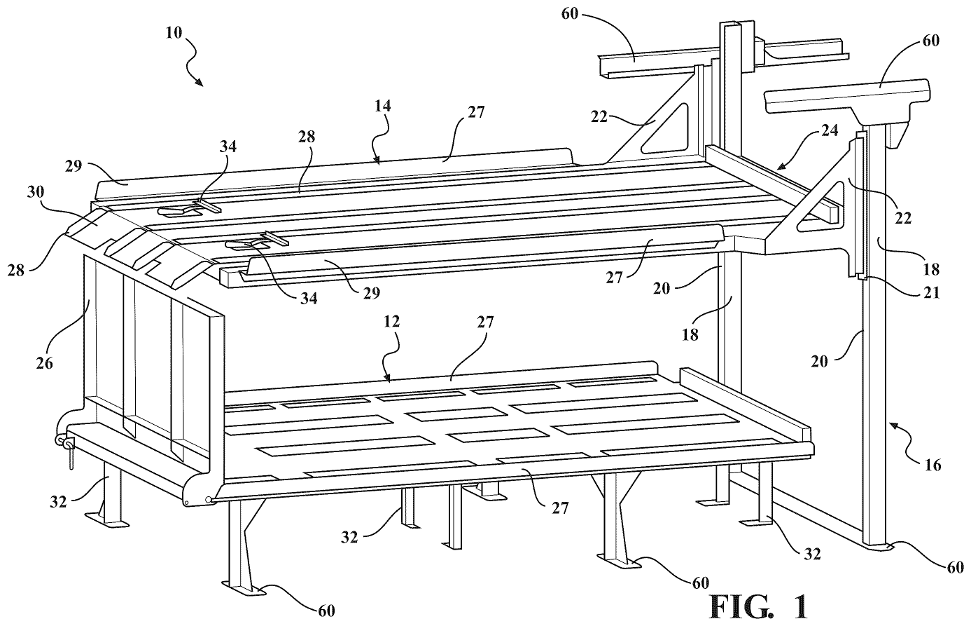

The casket transport of the present invention is shown generally at 10 in FIG. 1. The casket transport 10 includes a lower platform 12 and an upper platform 14. The upper platform 14 is adapted to raise and lower vertically with respect to the lower platform 12. In the disclosed embodiment, the upper platform 14 can lower closely adjacent to, onto, or nest with the lower platform 12. It will be understood that it is not necessary to engage the lower platform with the upper platform; when lowered, the upper platform can be closely adjacent the lower platform.

The upper platform 14 is mounted to a support 16, which includes posts 18 that contain tracks 20. As illustrated, mounting arms 22 operatively connect the upper platform 14 within the tracks 20. The mounting arms have mating tracks 21 that move within the tracks 20 of the posts 18 to raise and lower the upper platform 14 vertically. The upper platform 14 is cantilevered with respect to the support 16.

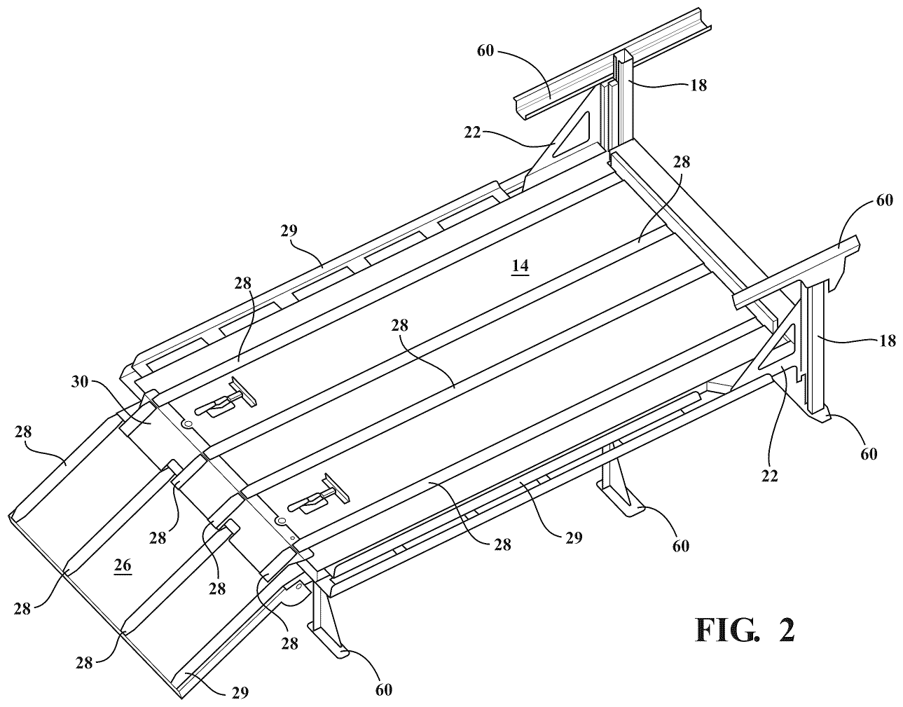

The lower platform 12 has a ramp 26 which pivots with respect to the lower platform 12. The ramp 26 can be pivoted from the raised position as illustrated in FIG. 1 to the lowered position as illustrated in FIG. 2. With reference to FIGS. 1 through 3 poly slide strips 28 are fixed to the ramp 26 and the lower platform 12 to facilitate the sliding of a casket up the short slight incline of the lower ramp 26 along the lower platform 12 for positioning on the lower platform 12. In the disclosed embodiment, there are two caskets positioned upon the lower platform 12 side-by-side. It will be appreciated that depending upon the size of the vehicle, additional caskets could be mounted on the platform 12 if it were made wider and/or longer.

The upper platform 14 includes a short, inclined ramp 30. In use, when the upper platform 14 is lowered to the lower platform 12, the ramp 30 engages the ramp 26 to provide a coextensive ramp for loading caskets onto the upper platform 14. Again, two caskets can be loaded side-by-side in the disclosed embodiment, but additional caskets could be loaded, depending upon the width and size of the upper platform.

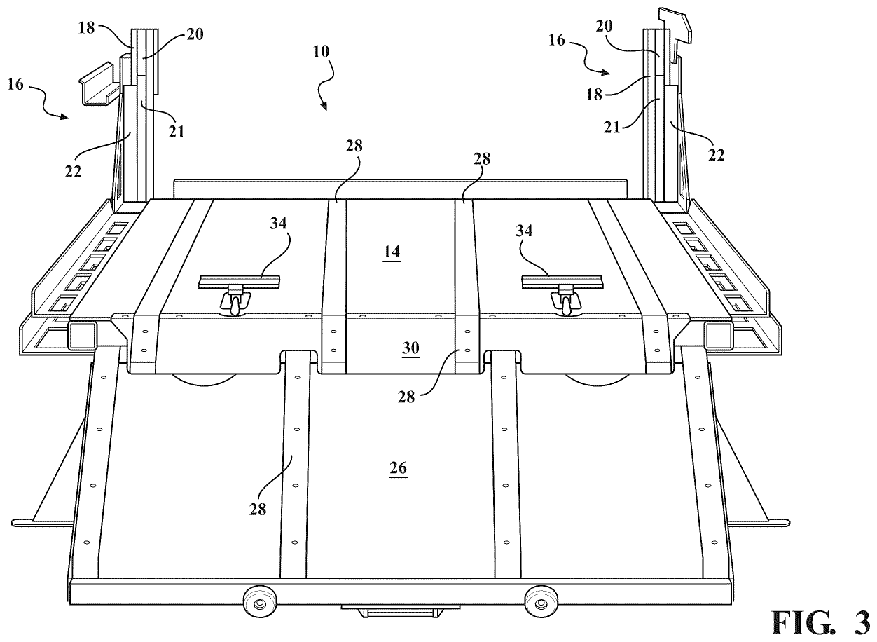

The engaging of the inclined ramp 30 with the ramp 26 is shown in FIGS. 2 and 3 when the upper platform 14 is adjacent the lower platform 12. It will be understood that the upper platform 14 does not have to engage the lower platform.

As illustrated, the lower platform is mounted upon legs 32 which raises the platform with respect to the vehicle into which the casket transport 10 is mounted. The legs 32 are used when the casket transport 10 is mounted into for example, a transit vehicle, which has wheel wells inside. The legs 30 allow the upper and lower platforms to extend to the inner walls of the transport vehicle and not interfere with the internal wheel wells of the vehicle.

As illustrated in the figures, the upper platform 14 can include optional restraining latches 34. These latches 34 retain the caskets upon the platform and restrict movement. The ramp 26 performs the same function on the lower platform 12 when it is raised as shown in the figures. Guide rails 27 can also be provided along the sides of the upper 14 and lower 12 platforms.

The mechanism 24 for raising the upper platform 14 with respect to the lower platform 12 is disclosed as a 12 V electric motor which powers a hydraulic pump that provides hydraulic fluid to a horizontal hydraulic cylinder 42. The horizontal hydraulic cylinder 42 is operatively connected to a flexible element shown generally at 41, which raises and lowers the upper platform 14. When the hydraulic cylinder is extended, the flexible element 41 raises the platform 14, and when the hydraulic cylinder is retracted, the flexible element 41 lowers the upper platform. It should be understood by those of ordinary school the art that other types of raising and lowering mechanisms could be used.

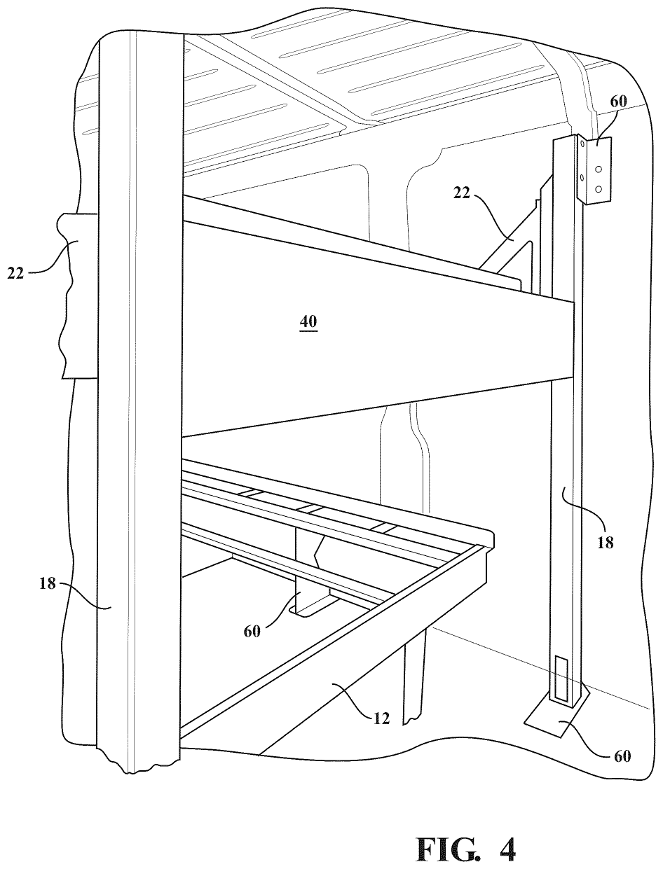

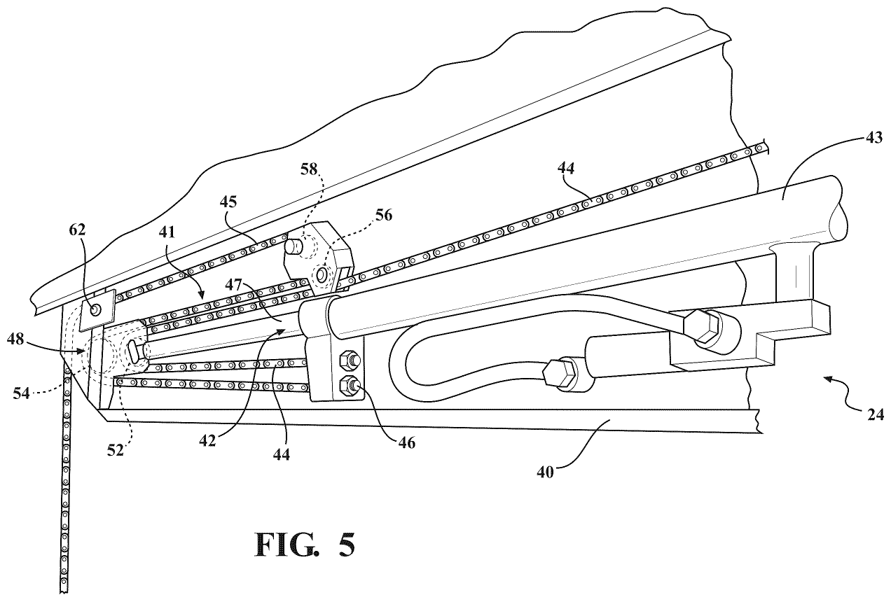

With reference to FIG. 5, the disclosed lift mechanism 24 for raising and lowering the upper platform 14 is shown. The lift mechanism 24 is mounted within a housing 40, see FIG. 4. Lift mechanism 24 features a hydraulic cylinder 42 that operatively engages flexible element 41, which in the disclosed embodiment includes two flexible members 44 and 45, which are shown as chains. It will be understood by those of ordinary skill in the art that the flexible members 44 and 45 could be cables, belts, etc., instead of the chains. It should also be appreciated by those of ordinary skill in the art that a single flexible element 44 or 45 could be used and only attach to one side of the upper platform 14. The chains 44 and 45 are connected to the upper platform and, in the disclosed embodiment, to the mounting arms 22. The cylinder 42 extends, as shown in FIG. 5, to raise the platform 14 and retracts to lower the platform 14. The hydraulic cylinder 42 includes a body 43, rod 47 and head 48.

In the disclosed embodiment, an electric pump is operatively connected to the hydraulic cylinder 42 to supply hydraulic fluid to the cylinder 42.

The chains 44 and 45 are each fixed at mount 46 and extend around the head 48 at the end of the rod 45 of the hydraulic cylinder 42. The head 48 has two spaced pulleys 52 and 54. The chain 44 is connected to the platform 14, and a guide or pulley 56 guides the chain 44, and a third pulley (not shown) changes the direction of the chain 44 from horizontal to vertical before connection to the upper platform 14.

The chain 45 extends around head 48 and in particular pulley 54. Chain 45 is then routed around pulley 58, and then a pulley at 62 changes the chain direction from horizontal to vertical. Both chains 44 and 45 are routed through the posts 18 in the disclosed embodiment.

When the cylinder 42 is extended, the chains 44 and 45 raise the upper platform 14, and when cylinder 42 is retracted, the chains 44 and 45 lower the platform 14. In the disclosed embodiment, a handheld controller is used to operate the pump.

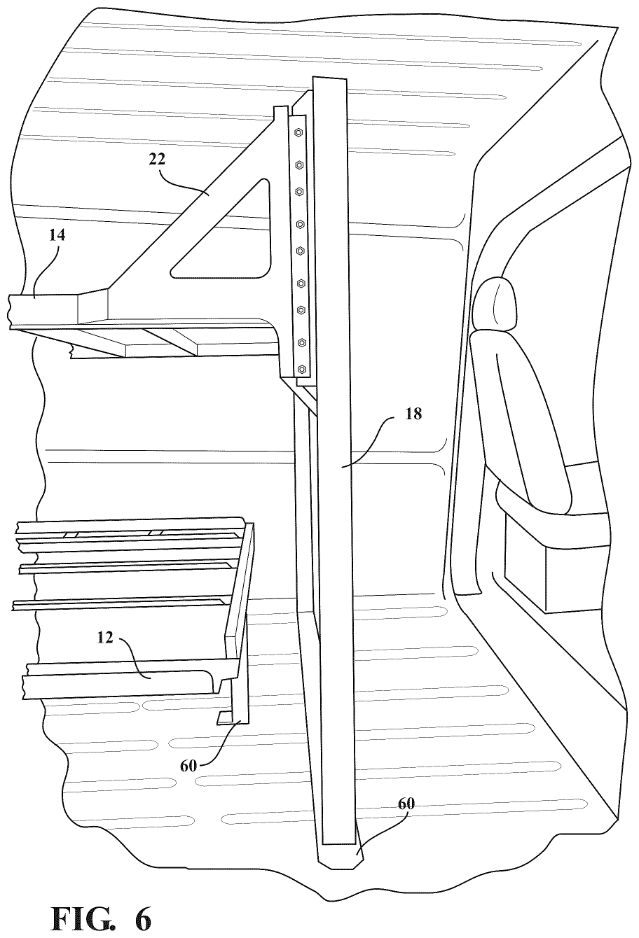

FIGS. 4 through 6 illustrate the casket transport mechanism mounted within a vehicle, with mounting brackets 60.

The casket transport of the present invention has the advantage of moving vertically without tilting. It also provides a simplified mechanism for transporting caskets. There are minimal moving parts, which results in a lower cost structure and less maintenance.

Vertical movement of the top platform 14 with respect to the lower platform 12 and close positioning of the top platform 12 with respect to the lower platform 14 provides for easier loading of caskets into the casket transport. Many known existing casket transports angle the upper platform with respect and the lower platform creating a steep incline for loading caskets. This is a disadvantage in known transports because it requires great effort by individuals loading caskets onto the steeply inclined upper platform. In the present invention, the upper platform 12 is basically at the same height and flat with respect to the lower platform 14. The small incline ramp 30 mates with the liftgate 26, leaving only a very slight incline and makes loading the upper platform much easier and ergonomically sound.

The foregoing invention has been described in accordance with the relevant legal standards. Thus, the description is exemplary rather than limiting in nature. Variations and modifications to the disclosed embodiment may become apparent to those skilled in the art and come within the scope of the invention. Accordingly, the scope of legal protection afforded this invention can only be determined by studying the following claims.

We claim:

1. A casket transport mechanism comprising:
a lower platform for the receipt of one or more caskets;
an upper platform having a front end and a rear end, for receipt of one or more caskets;
a support structure for supporting said upper platform, said upper platform is cantilevered at said front end from said support structure;
a lift mechanism;
said lift mechanism operatively coupled to said upper platform to move said upper platform along said support structure, between a raised position and a lowered position, said upper platform remaining substantially parallel to said lower platform as it moves between said raised and lowered positions;
whereby said upper platform can be lowered to facilitate the loading of caskets onto said upper platform, and then said upper platform can be raised to said raised position to allow loading of caskets onto said lower platform.

2. The casket transport mechanism of claim 1, further including a first ramp pivotally mounted to said lower platform.

3. The casket transport mechanism of claim 1, further including a second ramp mounted to said lower platform.

4. The casket transport mechanism of claim 1, further including a first ramp pivotally mounted to said lower platform and a second ramp mounted to said upper platform, said second ramp engaging said first ramp when said upper platform is in said lowered position.

5. The casket transport mechanism of claim 1, further including sliding strips mounted on said upper and lower platforms to facilitate sliding of a casket on said upper and lower platforms.

6. The casket transport mechanism of claim 1, further including mounting arms connecting said upper platform to said support structure.

7. The casket transport mechanism of claim 6, wherein said upper platform has opposing sides and two mounting arms, said mounting arms are connected to the front of said upper platform, with one mounting arm connected to one opposing side and the other mounting arm connected to the other opposing side.

8. The casket transport mechanism of claim 7, wherein said support structure includes spaced vertical posts.

9. The casket transport mechanism of claim 8, wherein said mounting arms each have a first track and said spaced vertical posts each have a second track, said first track of each mounting arm being received within a respective one of said second tracks for vertical movement of said upper platform with respect to said posts.

10. The casket transport mechanism of claim 1, wherein said support structure includes mounting brackets adapted to mount the upper platform in a vehicle.

11. The casket transport mechanism of claim 1, wherein said lift mechanism includes a flexible element interconnecting said lift mechanism to said upper platform.

12. The casket transport mechanism of claim 11, wherein said lift mechanism includes a hydraulic cylinder that operatively engages said flexible element to raise and lower said platform.

13. The casket transport mechanism of claim 11, wherein said lift mechanism includes a hydraulic cylinder, said flexible element includes a first flexible member and a second flexible member, said upper platform includes opposing sides and a first mounting arm and a second mounting arm, said first mounting arm is connected to one opposing side and said second mounting arm is connected to the other opposing side, said first flexible member is connected to said first arm and said second flexible member is connected to said second arm.

14. The casket transport mechanism of claim 12, wherein said hydraulic cylinder includes an extendable rod, said first flexible member has opposed ends with one opposed end mounted to a first mount and the other end mounted to said upper platform, and said second flexible member has opposed ends with one opposed end mounted to a second mount and the other end mounted to said upper platform, said first and second flexible members each extend around said rod of said hydraulic cylinder;
whereby extension and retraction of said rod raises and lowers said upper platform.

15. The casket transport mechanism of claim 14, further including first and second spaced pulleys, said first flexible element extending around said first pulley, and said second flexible element extends around said second pulley.

16. The casket transport mechanism of claim 15, further including a third pulley, said second flexible member is routed around said third pulley.

17. The casket transport mechanism of claim 12, wherein said hydraulic cylinder moves between an extended and retracted position along a path lateral to said upper platform.

18. The casket transport mechanism of claim 14, further including a guide that guides the flexible member from a horizontal path to a vertical path before connection to upper platform 14.

19. The casket transport mechanism of claim 1, wherein said lift mechanism includes a hydraulic cylinder and an electric pump operatively connected to said hydraulic cylinder to supply hydraulic fluid to said hydraulic pump.

20. The casket transport mechanism of claim 1, further including a handheld controller operatively controlling said lift mechanism.
